(19) United States
(12) Patent Application Publication
(10) Pub. No.: US 2005/0124478 A1
(43) Pub. Date: Jun. 9, 2005

(54) Side wall flap folding mechanism for carton forming machine

(75) Inventors: William John Scholtes, Pascoe Vale South (AU); Trevor H. Craven, South Yarra (AU); Craig A. Kirpatrick, Eltham North (AU); Andrew J. Goddard, Eltham (AU)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(73) Assignee: Visy R & D Pty Ltd

(21) Appl. No.: 11/032,279

(22) Filed: Jan. 10, 2005

(30) Foreign Application Priority Data
Jul. 27, 2000 (AU) PQ 9060

(51) Int. Cl. B31B 1/48

(52) U.S. Cl. 493/80

(57) ABSTRACT

A side wall flap folding mechanism 30 for a carton forming machine including blank feeding means 50 operative to move the blanks B in a predetermined direction, a side flap folders 32 for folding side wall flaps st, located on opposite sides of the blanks B, about a predetermined fold line F and opposite to the direction of movement of the blanks, and means 31 for confining the folding of the flaps to the predetermined fold line F.

### CROSS REFERENCE TO RELATED APPLICATION

This application is a Continuation-in-Part of U.S. patent application Ser. No. 10/343,032 filed Jul. 17, 2003, which is the national stage of International Patent Application Serial No. PCT/AU01/00913 filed Jul. 26, 2001, which claims the priority of Australian Patent Application Serial No. PQ 9060 filed Jul. 27, 2000, all of which are hereby incorporated herein by reference.

### FIELD

This specification relates to a side wall flap folding mechanism for a carton forming machine.

### BACKGROUND

Carton forming and filling machines are now widely used in the packaging of consumer products such as beverages. Such machines must be capable of automatically erecting and sealing the carton or case ready for filling by means of a separate filling apparatus.

Examples of carton or box forming machines may be found in the patent literature, and include Australian Patent No. 640503, and U.S. Pat. No. 5,147,271, in both of which a corrugated cardboard blank is formed around a mandrel where the side and end panels are glued and the partly erected box is ejected from the mandrel as an open-topped box ready for filling.

In our International Patent Application PCT/AU00/01215, published Sep. 13, 2001 as Publication No. WO0166423 filed Sep. 9, 2002 as U.S. patent application Ser. No. 10/221,073), the contents of which are incorporated herein by reference, we describe a reinforced container suitable for fluid-filled bags or other contents, formed from corrugated board or similar packaging materials and including side panels having extension portions which are foldable and secured to form double thickness side panels and end flaps which serve to reinforce the side and end panels of the container. It will be appreciated that the blank for forming the improved reinforced container is large and a modified flap folding arrangement is described in which the side flaps are initially folded lengthwise rather than transversely, as is usually the case, followed by folding of the blank around a mandrel to form the carton.

### SUMMARY

It is an object to provide a side flap folding means for a case forming machine in which the blanks are folded in a manner which ensures substantially continuous operation at a relatively high throughput.

The present specification discloses a side flap folding mechanism for carton forming machine, comprising a blank feeder operative to move a blank in a predetermined direction, side flap folders for folding side wall flaps at opposite sides of the blank about a predetermined fold line extending transverse to the direction of movement of the blanks to form double thickness side walls, the side wall flaps being folder opposite to the direction of movement of the blanks, the side flap folders including means for confining the folding of the side wall flaps to the predetermined fold line.

In one form, the fold confining means includes arms, each arm having an edge which is positioned adjacent the predetermined fold line while the blank feeder is paused to allow initial folding of the flaps through about 90°.

The mechanism may also include means, such as centre wheels or a driven hold down belt, to hold the centre of the blank down as the side wall flaps are folded.

The flap folders may comprise any known form of flap folding mechanisms, such as rotating folding arms which operate to fold the side flaps longitudinally as the blank is moved by the feeding means. Initial bending of the side flaps through about 90° while the blanks are held at the predetermined fold line may be by way of rotating folding arms, and this folding operation may be followed by the use of compressor rollers or belts to complete the folding of the side flaps through 180°.

The side flaps are held in compression by the rollers or belts for a period sufficient to ensure that the glue between the folded flap portions sets.

The specification further discloses a method of forming a carton from a blank having elongate side wall flaps, comprising the steps of folding the side wall flaps lengthwise about a transverse fold line, gluing the folded side wall flaps to form double thickness side panels, and completing folding and gluing of the blank to form the carton.

In one form the folding step comprises holding the side wall flaps adjacent the transverse fold line, folding the side wall flaps through about 90° along the transverse fold line, completing folding of the side wall flaps through 180°, and compressing the folded side wall flaps to set glue between the folded portions of the side wall flaps.

The method may further comprise supporting the side wall flaps at their inner edges and transversely of the flaps during folding of the side wall flaps through 90°, removing the edge support from the side wall flaps, and moving the blank forwardly so that the transverse support further folds the flaps from 90° towards 180°.

### BRIEF DESCRIPTION OF THE DRAWINGS

In order that the disclosure may be more readily understood, a presently preferred embodiment of the invention will now be described with reference to the accompanying drawings in which:

FIGS. 1 and 2 are partly schematic perspective views of a blank side flap folding mechanism in the rest and operative positions respectively;

FIG. 3 is a partly schematic perspective view of the folding mechanism of FIGS. 1 and 2 illustrating the blank feeder and the flap folding and compressing mechanisms; and

FIG. 4 is a partly schematic perspective view of the folding mechanism showing the glue applicators.

### DESCRIPTION OF EMBODIMENT

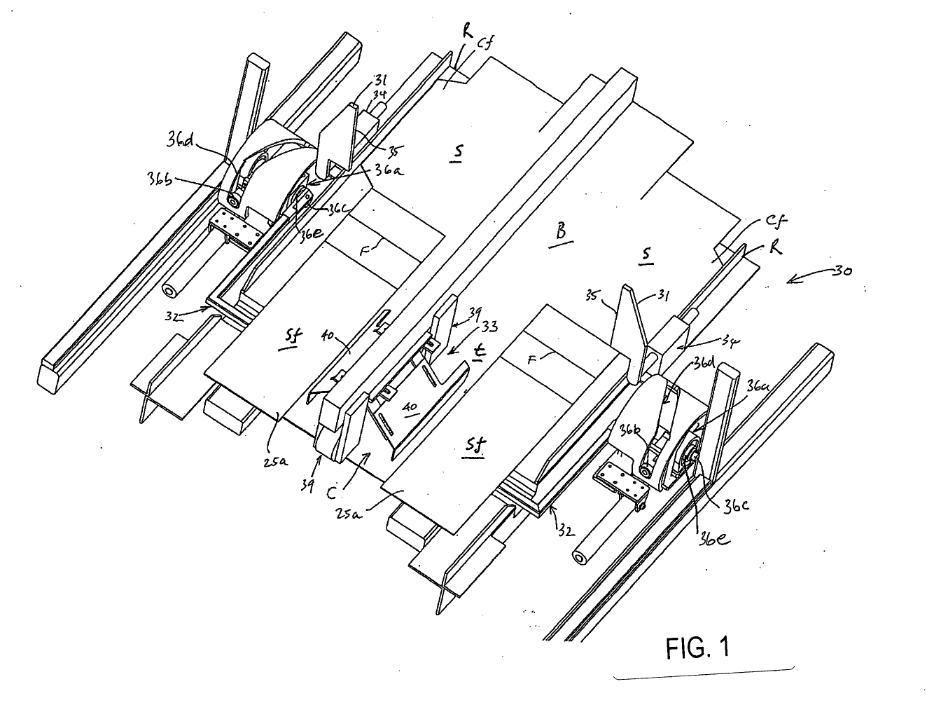

The present embodiment is designed to perform the first folding operation of the side flaps sf of a carton blank B, as illustrated in FIGS. 1 to 3. The blank B is a modified version of the blanks described in co-pending U.S. patent application Ser. No. 10/221,073, Holland, to the extent that closure flaps cf extend from the side panels of the blank B rather than from the top, the side flaps sf extending from the side panels on either side of the central portion C of the blank B, the side flaps sf including a predetermined fold line F about which the side flaps sf are folded by the mechanism to be described below to form double thickness sides in the eventually formed carton, as described in the co-pending application referred to above.

FIGS. 1 to 3 illustrate an embodiment of a side flap folding mechanism 30 which replaces the mechanism described in parent application Ser. No. 10/343,032 Scholtes, and which enables the long side flaps sf of the blank B to be folded and glued without comprising the integrity of the blank B. Mechanisms for feeding or supplying the blanks to the folding mechanism 30, and mechanisms for completing the folding of the blank B partly folded by the mechanism 30 are well known to those of skill in the art and are therefore not described herein. Reference may be had to parent U.S. patent application Ser. No. 10/343,032 Sholtes, for a description of one form of a blank feeder and mechanisms for completing folding of the blank B of a complete carton forming machine of which the folding mechanism 30 forms a part.

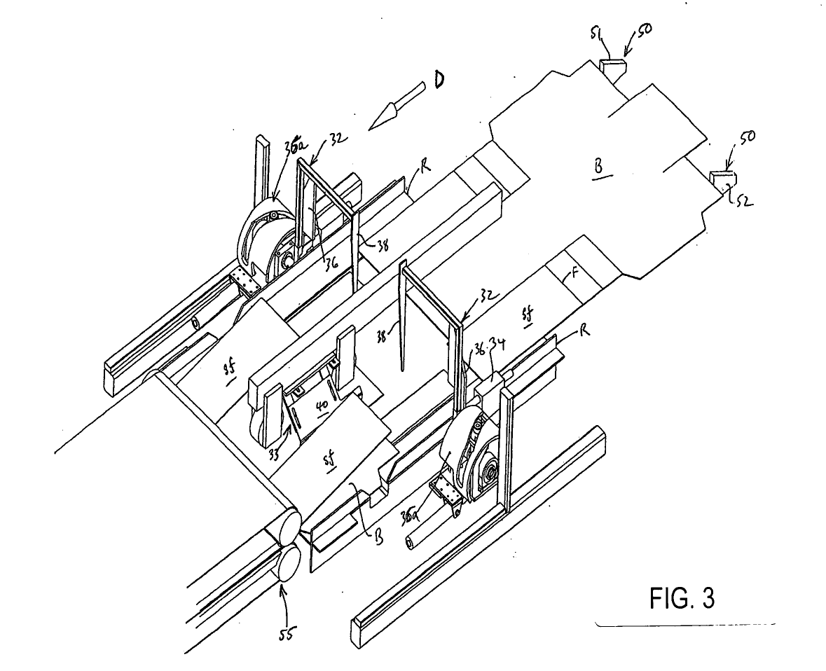

As shown in FIGS. 1 to 3, blanks B supported by side rails R are fed to the side flap folding mechanism 30 by a blank B feeding mechanism 50, which includes known re-circulating dogs 51, 52, illustrated schematically in FIG. 3, which engage the rear edges of the blanks B as illustrated in FIG. 3 to move them generally in direction D through the mechanism 30. Mechanism 50 has at least a paused state in which it is not advancing the blank B, and an operative state in which it is advancing the blank B.

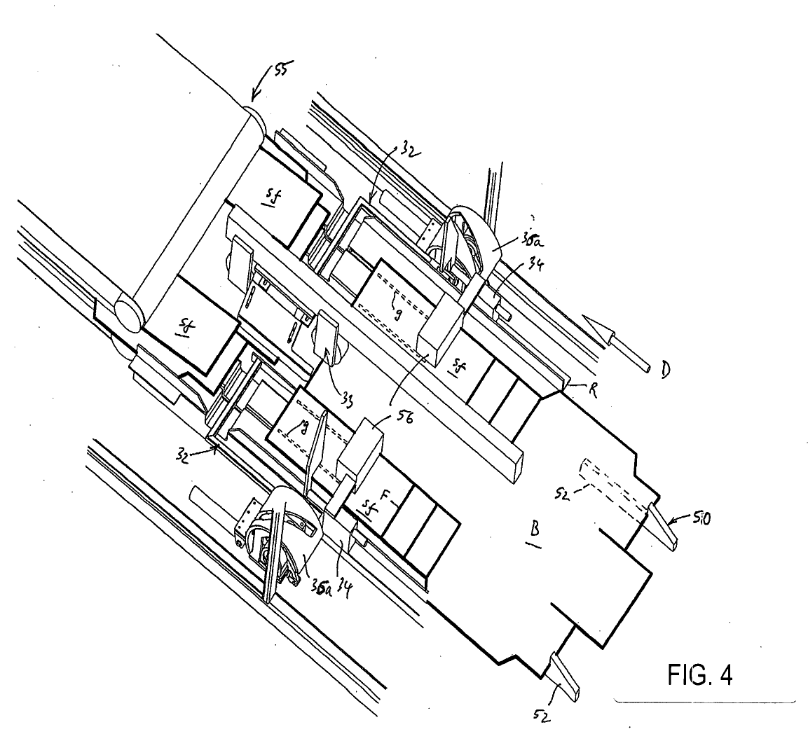

The mechanism 30 includes a pair of fold confining arms 31, and a pair of folding arms 32, which operate to fold the side flaps st, which have been previously glued by glue applicators 56, FIG. 4, while the blank B feeding mechanism 50 is paused for a short period in a known manner. It will be noted that the folding arms 32 include a driven arm 36 extending from a driving mechanism 36a, a cross member 37, and a side flap edge support element 38, which provides support for the side flaps st so that the cross members 37 and the support elements 38 lift and rotate the side flaps st, rather than just the cross members 37 lifting and rotating the side flaps st. This ensures that the slide flap is folded along the predetermined fold line F without buckling. The driving mechanism 36a includes a cam follower 36b attached to the drive shaft 36c and engaging a cam slot 36d, the shaft 36c being mounted in bearings 36e which allow lateral movement of the shaft 36c as it is rotated.

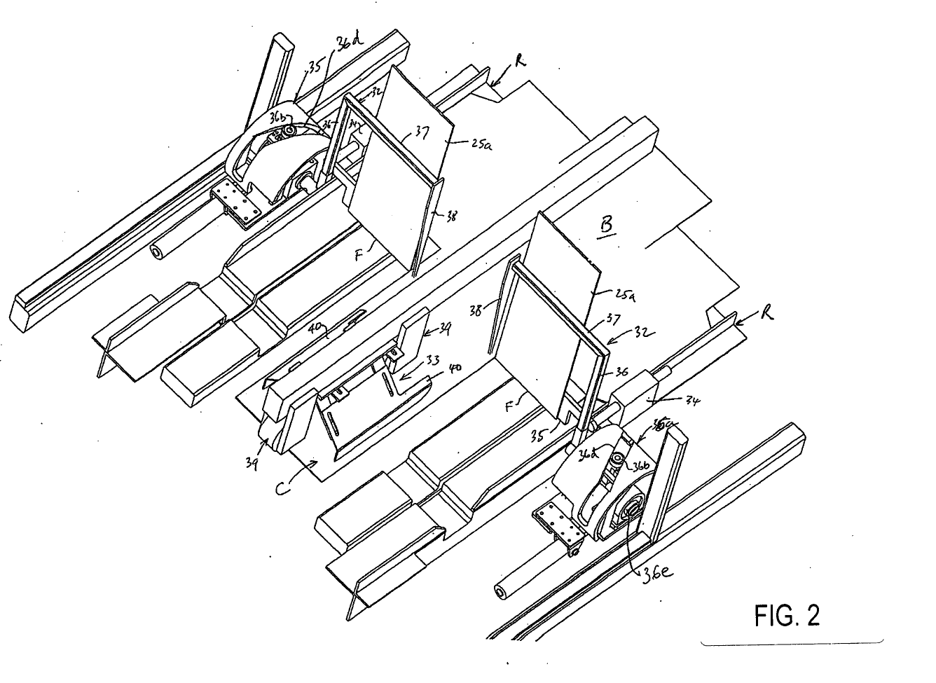

The fold confining arms 31 are driven by motors 34 between a substantially vertical or retracted position, as shown in FIG. 1, to allow for the positioning of a new blank B by the feeding mechanism 50, and a substantially horizontal or operative position, as illustrated in FIG. 2, in which lower edges 35 of the arms 31 are in contact or close proximity with the blank B in alignment with the predetermined fold line F of the side flaps sf, as illustrated in FIG. 2.

When the arms 31 are in the operative position and while the blank B is temporarily stationary, the folding arms 32 are rotated by their driving mechanisms 36a to a substantially vertical position, as illustrated in FIG. 2. During rotation, the arms 32 are moved laterally by about 10 mm by the cam follower 36b in the cam slot 36d of the drive mechanism 36a so that the edge support elements 38 are clear of the edges of each side flap sf. The fold confining arms 31 are moved to their rest or retracted positions during or after rotation of the folding arms 32. The blank B is then fed forwardly by mechanism 50 to further fold the side flaps sf, to the position shown in FIG. 3, by engagement between the side flaps and the support 38 of the fold arms 32 as the blank B moves forward. The arms 32 are then returned to their rest position (FIG. 2) below the level of the blank B, to enable feeding of a new blank B to the folding position. Initially, the support element 38 is beneath a side flap st and, once rotation of the support element 38 has begun, and preferably before the blank B has begun moving forward again, the support element 38 is moved laterally so as not to interfere with or damage the side flap st. Note that, by virtue of the action of the cross member 37 and the support element 38, the side flap st may be considered to be folded opposite to the direction of movement D of the blank B.

During the folding operation, the central portion C of the blank B is held down by a hold down mechanism 33 in which the central portion C of the blank B is trapped under pressure rollers 39 and confining plates 40 carried by the frame of the mechanism.

The folding of the side flaps sf is completed by passing the further folded flaps between a known compression belt mechanism 55, as illustrated in FIG. 3. The folded side flaps are held in the belt mechanism 55 for a sufficient time for the glue previously applied to the side flaps sf to set.

As illustrated in FIG. 4, glue applicators 56 are mounted on the motors 34 adjacent the fold confining arms 32 and are operable in a known manner to apply glue lines g to the side flaps sf as the blanks B are moved to the folding position by the feeding mechanisms 50.

The above described mechanism allows blanks B to be folded in the above described manner at relatively high throughput rates without comprising the integrity of the side flaps, to allow the formation of a completed carton, as described in U.S. Ser. No. 10/343,032, and similar to the carton described in U.S. Ser. No. 10/221,073 Holland, having reinforced side walls and end walls.

1. A side wall flap folding mechanism for a carton forming machine, the mechanism comprising: blank feeding means having at least a paused state and an operative state and, in the operative state, moving a blank in a predetermined direction of movement, and side wall flap folding means for folding side wall flaps at opposite sides of the blank, each side wall flap being folded about a predetermined fold line extending transverse to the predetermined direction of movement and being folded opposite to the direction of movement to form double thickness side walls, said side wall flap folding means including means for confining the folding of the side wall flaps to said predetermined fold line.

2. The mechanism of claim 1, further comprising means for positioning, when said blank feeding means is in the paused state, a said fold confining means adjacent each of the predetermined fold lines, and wherein the said side wall flap folding means comprises means for folding the side wall flaps through at least approximately 90° along said predetermined fold line.

3. The mechanism of claim 1 or claim 2, further including means for applying glue to the side wall flaps, wherein the side wall flap folding means folds the side wall flaps to a folded position in which they overlie the side walls of the blank, and wherein the mechanism further comprises means for holding the side wall flaps in the folded position while the glue at least partially sets.

4. The mechanism of claim 1 or claim 2, wherein the confining means includes a hold down arm having an edge which is aligned in use with said predetermined fold line.

5. The mechanism of claim 1 or claim 2, wherein said side wall flap folding means includes a folding arm movable from a rest position below the side wall flaps of the blank to an operative position in which a said side wall flap is folded.

6. The mechanism of claim 5, wherein the folding arm includes a side wall flap edge supporting element which operates to support the edges of the side wall flaps at least during initial folding and wherein the side wall flap folding means further comprises means for moving the folding arm laterally so that the edge supporting element clears the blank, the folding arm continuing the folding of the flap to a position overlying the remainder of the side wall of the blank as the blank is moved forwardly by said feeding means.

7. The mechanism of claim 6 wherein the folding arm includes a driven portion and a transverse portion, said edge supporting element extending from said transverse portion, said transverse portion operating to continue folding the flap as the blank is moved in the predetermined direction after the lateral movement of the folding arm.

8. The mechanism of claim 5, wherein the folding of the side flaps is completed by a compression device which holds the side flaps of the blank in a folded position.

9. The mechanism of claim 8 wherein the compression device is at least one of compression belts and rollers.

10. The mechanism of claim 5, further including means for holding down the centre of the blank as the side flaps are folded.

11. The mechanism of claim 10, wherein the means for holding down comprises at least one of centre wheels or hold down plates overlying the blank.

12. The mechanism of claim 6, further including means for holding down the centre of the blank as the side flaps are folded.

13. The mechanism of claim 12, wherein the means for holding down comprises at least one of centre wheels or hold down plates overlying the blank.

14. A method of forming a carton from a blank being moved in a predetermined direction and having elongate side wall flaps, comprising the steps of: applying glue to the side wall flaps, folding the side wall flaps lengthwise about a transverse fold line and opposite the predetermined direction of movement of the blank to form double thickness side panels, and completing folding and gluing of the blank to form the carton.

15. The method of claim 14, wherein the folding step comprises holding the side wall flaps adjacent the transverse fold line, folding the side wall flaps through at least approximately 90° along said transverse fold line, completing folding of the side wall flaps through 180°, and compressing the folded side wall flaps until the glue between the folded portions of the side wall flaps is at least partially set.

16. The method of claim 15, further comprising supporting the side wall flaps at their inner edges and transversely supporting the flaps at least during initial folding of the side wall flaps through at least approximately 90°, removing said inner edge support from the side wall flaps, and moving the blank in the predetermined direction so that the transverse support further folds the flaps.
